(19) United States
(12) Patent Application Publication
(10) Pub. No.: US 2007/0018803 A1
(43) Pub. Date: Jan. 25, 2007

(54) System for automatically assessing tire condition and method for using same

(76) Inventor: Daniel O. Lang, Yardley, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/186,377

(22) Filed: Jul. 20, 2005

(51) Int. Cl. B60C 23/02

(52) U.S. Cl. 340/442

(57) ABSTRACT

Systems and methods for determining the condition of a tire are described. A system for determining a condition of a tire includes having at least one tire measurement device to measure a tire characteristic as a tire passes through the tire measurement system and a processor for receiving and analyzing the tire characteristic to determine the condition of the tire. The system may also include a display device for displaying the condition of the tire to a user. A method for determining a condition of a tire includes determining the condition of the tire, comparing the condition of the tire to an acceptable standard, and communicating the condition of the tire. The method can include identifying the tire using a tire identification device.

### FIELD OF THE INVENTION

The present invention relates generally to determining the condition of tires, and more particularly, to assessing the pressure of tires.

### BACKGROUND OF THE INVENTION

According to two separate studies by the Canadian government and the National Highway Transportation and Safety Agency (NHTSA), as many as 67% of vehicles are operating with improperly inflated tires. Operation of vehicles having underinflated tires can result in overheating, blowouts, uneven tread wear, excessive fuel consumption, and even fatal accidents. Further, overinflation shortens the tire life span and can affect the handling of the vehicle. The NHTSA estimated that if 2003 model cars came equipped with tire pressure monitoring systems (TPMS), some 280 deaths and more than 10,000 injuries could be avoided per year.

As a result of the Ford-Firestone Tire Recall of 2000, new federal guidelines in the TREAD act require new vehicles to be equipped with tire pressure monitoring systems starting in 2004. The government, however, will not require that all vehicles have tire pressure monitors until the 2007 model year. The government intends to make a final decision in 2005. Until then, carmakers can meet phase-in requirements by using either direct or indirect systems.

The direct or indirect systems can comply with the government regulations in one of two ways. In the first option, the system can warn the user if one or more tires are 25% below the recommended cold inflation pressure. Under the second compliance option, the system must warn if any single tire is below the 30% recommended cold inflation pressure.

Most manufacturers will likely use the speed sensor or indirect system that is part of the Antilock Braking System (ABS). This indirect system can test for a difference in the rotation speed between each of the tires. The indirect system works by comparing the difference at which all four wheels are rotating. For example, if one tire is spinning slower than the rest of the tires, an inflation problem is reported. However, if all four tires were equally underinflated, no pressure problem would be reported. Car manufacturers prefer this system because it is very inexpensive to implement.

The manufacturer's preferred indirect system, however, reveals limited information about tire inflation problems and issues. Also, the indirect system does not indicate which tire is underinflated, and if all four tires are equally underinflated, no inflation problem is reported. Further, in testing, the National Highway Transportation Safety Agency (NHTSA) found that these systems did not work well unless there was significant turning or velocity of the vehicle.

Direct methods, which are more expensive to implement, have also been proposed. Direct systems having individual pressure monitors either inside or on the valve stem of each tire have been implemented. In these types of systems, a radio signal can be transmitted to the dashboard instrumentation indicating the tire pressure. Although significantly more expensive than indirect methods, direct methods give more complete information about tire pressure. These direct methods are deficient, however, because they are expensive to implement and are difficult to retrofit on existing vehicles in use.

In view of the foregoing, there is a need for methods and systems that overcome the limitations and drawbacks of the prior art.

### SUMMARY OF THE INVENTION

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

A system and method for assessing a tire condition is described. Tire parameters and characteristics can be measured while the tire is in motion. Measurements including the contact patch, longitudinal distance, the difference in tread temperatures across a tire tread, and the strain, stress, and pressure placed on a tire treadle. The measurements can then be used to determine the condition of the tire before further use. A display device can report the tire pressure and condition to a driver. Further, a communicating device such as a signal device can be used to communicate with a tire management system on an automobile, for example, to inform the management system for proper correction.

The system and method for assessing a tire condition can be implemented on an electronic toll collection system, for example. The system and method for assessing a tire condition can also be implemented independently from an electronic toll collection system.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an exemplary diagram showing a contact patch analysis system;

FIG. 2 is a flow diagram showing an exemplary process for determining the condition of a tire using contact patch analysis;

FIG. 3 is an exemplary diagram showing an image analysis system;

FIG. 4 is an exemplary diagram showing a close up view of an image analysis system;

FIG. 5 is an exemplary diagram showing the measurement of the longitudinal distance of a tire;

FIG. 6 is a flow diagram showing an exemplary process for determining the condition of a tire using image analysis;

FIG. 7 is an exemplary diagram showing an infrared analysis system;

FIG. 8 is an exemplary diagram showing a close up view of an infrared analysis system;

FIG. 9 is a flow diagram showing an exemplary process for determining the condition of a tire using infrared analysis;

FIG. 10 is an exemplary diagram showing a strain analysis system;

FIG. 11 is an exemplary diagram showing a close up view of a strain analysis system; and

FIG. 12 is a flow diagram showing an exemplary process for determining the condition of a tire using strain analysis.

### DETAILED DESCRIPTION OF ILLUSTRATIVE EMBODIMENTS

Overview

A tire, coupled to a moving conveyance, can be assessed to determine its condition to prevent a failure. A conveyance can be, for example, a car, a truck, a motorcycle, a tractor, a trailer, and the like. A conveyance can also include, for example, devices pulled by automobiles or trucks for transporting items of interest. A treadle can be used to measure the treadle depression time interval. A velocity sensor can determine the velocity of the tire as it passes through the system. The treadle depression time interval and velocity can be used by a processor to determine the contact patch of the tire. The contact patch of the tire as it passes through the system can then be compared with a predetermined contact patch value to determine the current condition of the tire. The processor can calculate whether the tire condition is satisfactory or whether there is an issue with the condition of the tire.

The processor can also use the treadle depression time and velocity to determine the tire pressure of the tire. The tire pressure can then be compared against a predetermined tire pressure stored in a central processing unit (CPU) or database, for example, to determine whether the tire is under or overinflated or in a satisfactory condition.

The condition of a tire can also be evaluated using an optical system. An optical system can be used to measure the longitudinal distance of the tire. The longitudinal distance can be used by the processor to determine the condition of a tire by comparing the longitudinal distance with a predetermined longitudinal distance. The processor can then calculate whether the tire condition is satisfactory or whether there is an issue with the condition of the tire.

The processor can also use the longitudinal distance of the tire to determine the tire pressure of the tire. The tire pressure can then be compared against a predetermined tire pressure stored in a CPU or database, for example, to determine whether the tire is under or overinflated or in a satisfactory condition.

The condition of a tire can also be evaluated using an infrared system. An infrared temperature sensor can be used to measure the temperature of the tire tread. Determining the temperature of the tread at different locations across the tire tread can indicate whether a tire is underinflated or overinflated. For example, tires that are underinflated are likely to have higher temperatures on the outer-most treads. Tires that are overinflated, however, will have higher temperatures approximate to the middle portions of the tread, for example.

The condition of a tire can also be evaluated using strain gages or pressure gages staggered across the pathway of the tire. The data received from the pressure or strain gages can then be compared against predetermined pressure or strain measurements stored in a CPU or database, for example, to determine whether the tire is under or overinflated or in a satisfactory condition.

The condition of a tire can also be evaluated using a combination of the above systems to provide multiple measurements to ensure a more accurate reading of the condition of a tire.

### Exemplary Embodiments

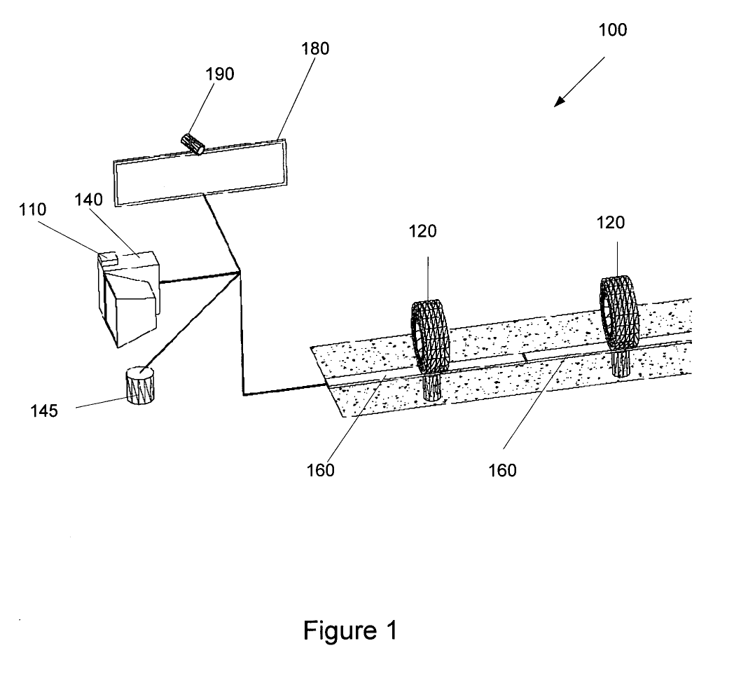

FIG. 1 shows an exemplary measurement system 100 in accordance with the present invention. A tire identification device 110 can be used to identify a tire 120 as it passes through the tire measurement system 100. The tire identification device 110 can send the identity of the tire 120 to a processor 140. The processor 140 can then initialize a tire measurement device 160. The tire measurement device 160 can be a pressure sensitive treadle, for example. There can also be a plurality of measurement devices 160 to provide measurements for multiple tires 120 running through the system 100 The tire measurement device 160 can take measurements as the tire 120 passes across the treadle, for example. A speed or velocity sensor 190 can determine the velocity of the tire 120 as it passes through the tire measurement system 100. The tire measurement device 160 and velocity sensor 190 can send their measurements to the processor 140 for determination of the condition of the tire 120. The processor 140 can compare the measurements of the tire 120 with predetermined measurements in a database 145, for example. After determination of the condition of the tire 120, the processor 140 can send a message to a user, through the display device 180 concerning the condition of the tire. The condition of the tire 120 can also be relayed to a tire management system through a communicating device (not shown).

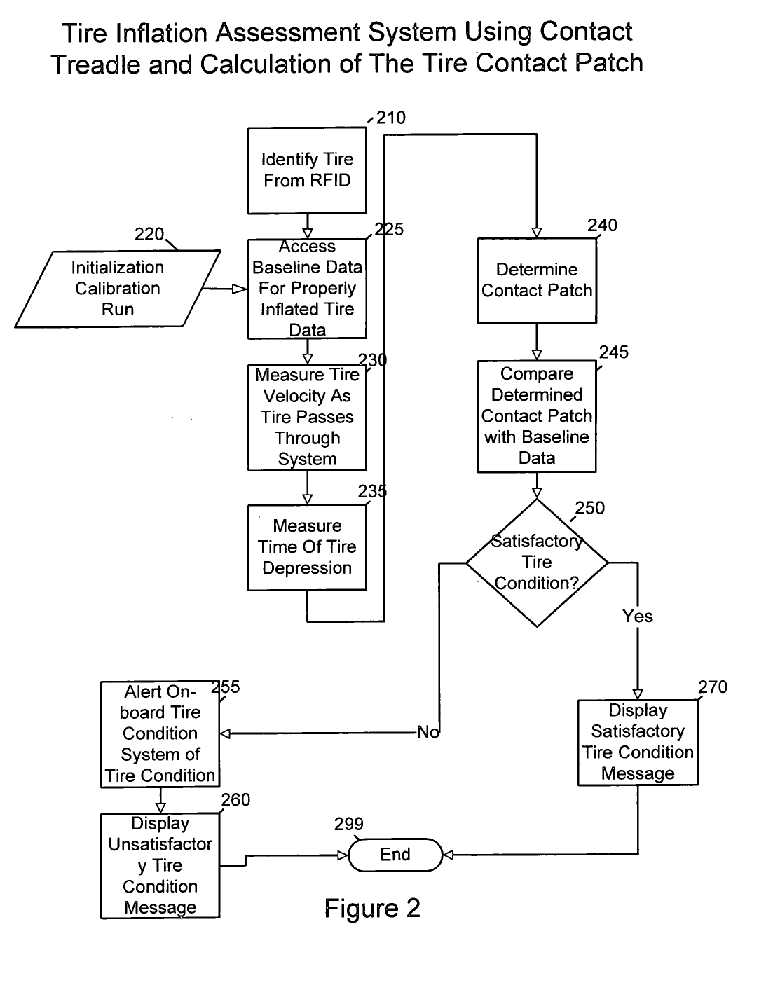

FIG. 2 is a flow diagram of an exemplary process for determining the condition of a tire using contact patch analysis. Initially, as step 210, a tire is identified. The tire can be identified, for example, by using the Radio Frequency Identification Device (RFID) of the EZ Pass system. The RFID can be used to identify the vehicle or trailer, for example, and the corresponding tire can be determined based on the identity of the vehicle or trailer. The tire can be, for example, an automotive or truck tire, a motorcycle tire, or a trailer tire. The tire may also be other types of tires found on other carrier or vehicular devices. Once the tire is identified, a processor at step 225, for example, can access a baseline database to determine the tire characteristics of the tire in an acceptable condition. The acceptable condition can be determined through an initialization calibration run, at step 220, performed on the tire prior to use in the measurement system. The information on the tire characteristics in an acceptable condition may vary pending on climatic conditions and location. For example, the tire characteristics in an acceptable condition found in the database in Anchorage, Ak. can vary from those found in the database in Austin, Tex. The velocity of the tire is then determined at step 230. The velocity of the tire can be determined through the use of a speed sensor, for example. After the velocity of the tire is determined at step 230, the tire depression time interval can be determined at step 235. The tire depression time interval comprises the amount of time a tire tread is in contact with the treadle, for example, as it moves across the treadle surface. After the tire depression time interval is determined at step 235, the contact patch can be determined at step 240. The contact patch can be determined by taking the determined velocity of the tire and dividing it by the tire depression time interval. The contact patch value can then be compared at step 245 against a predetermined contact patch in the database to determine the current condition of the tire. If the condition of the tire is unsatisfactory at step 250, the system can send a signal to a tire management system, for example, to inform the system of the condition of the tire and the suggested correction at step 255. Further, if the condition of the tire is unsatisfactory, the system can output the condition of the tire to a user to warn the user of the possible hazardous condition at step 260 and the process will conclude at step 299. If the tire condition is satisfactory at step 250, the system can output the satisfactory condition of the tire to the user at step 270 and conclude at step 299.

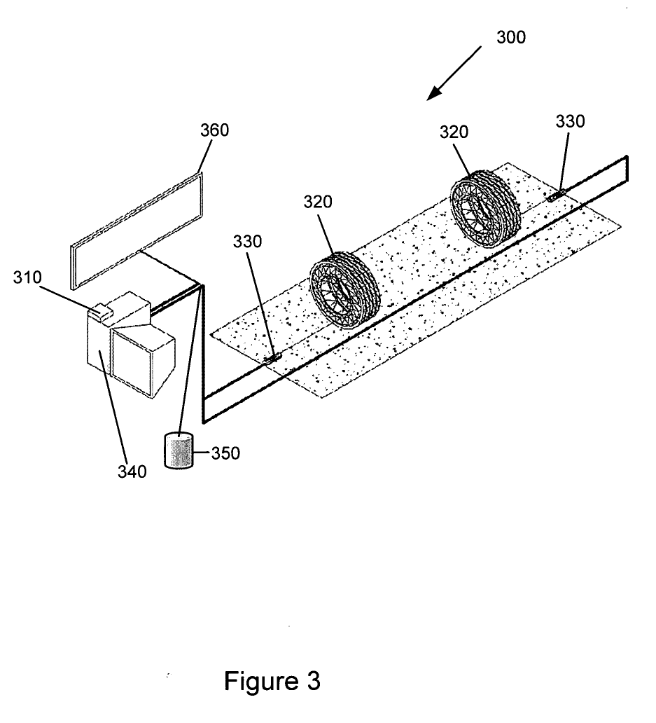

FIG. 3 is a diagram of an exemplary system implementing an image measurement system 300 in accordance with the present invention. The image measurement system 300 comprises a tire identification device 310 that can be used to identify a tire 320 as it passes through the system 300. The image measurement system 300 also includes a tire measurement device 330 that can take images of the tire 320 for analysis by the processor 340. The image measurement system 300 can also include a plurality of tire measurement devices 330 to cover multiple tires 320 passing through the system 300. The measurement device 330 can be a digital imaging device, for example. The processor 340 can determine the longitudinal distance of the tire 320 to determine the condition of the tire 320. The processor 340 can compare the longitudinal distance of the tire 320 with a predetermined longitudinal distance stored in a database 350, for example, to determine the condition of the tire 320. The processor can also compare the present tire shape to the shape of the tire 320 stored in the database 350 to determine tire condition. For example, the processor can detect bulges or other spots on the tire 320 that may indicate improper wear or condition. After determination of the condition of the tire 320, the processor 340 can, for example, output messages to a user (e.g., an automobile driver) through a display device 360 concerning the condition of the tire 320.

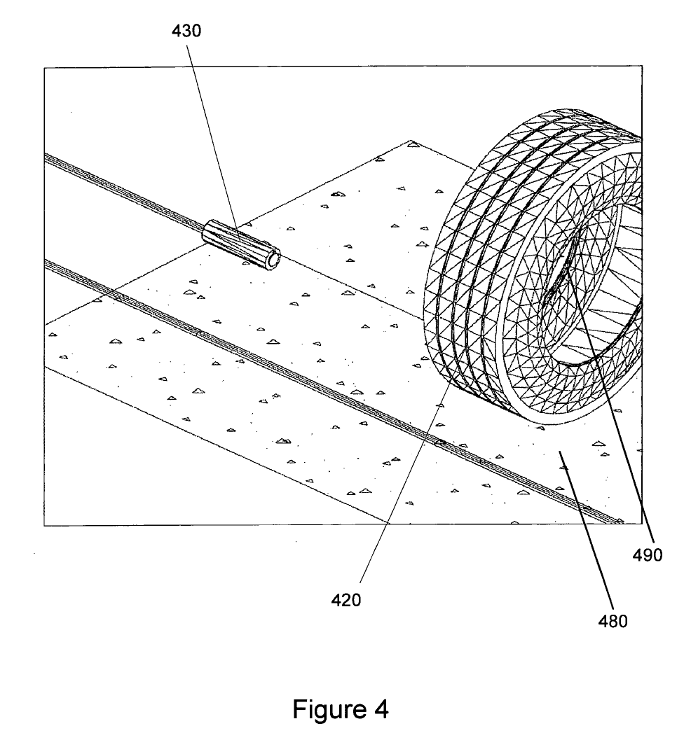

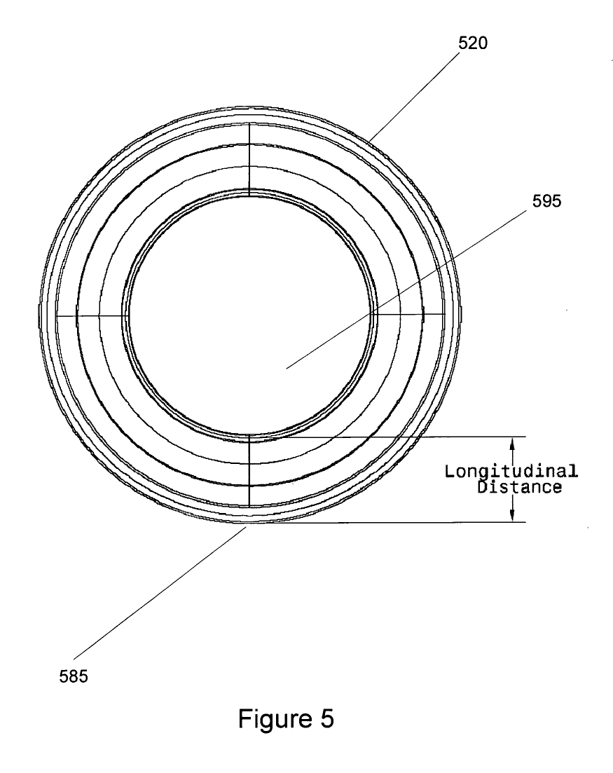

FIG. 4 is an exemplary diagram showing a close up view of an image analysis system. As shown in FIG. 4, the tire measurement device 430 can be positioned to properly detect the longitudinal distance of the tire 420. The longitudinal distance is the distance between the point where the tire 420 is in contact with the road surface 480, for example, and the point where the tire surface contacts the tire rim 490. The longitudinal distance measurement (i.e. the distance between the road surface 585 and the tire rim 595) of the tire 520 is shown in FIG. 5.

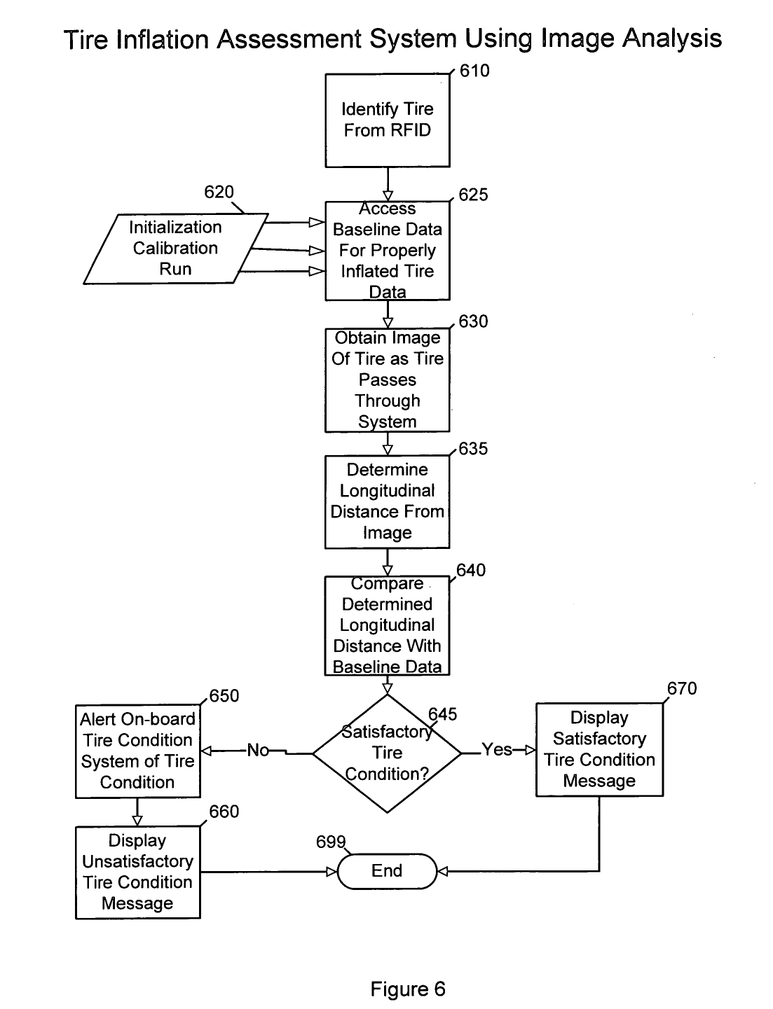

FIG. 6 is a flow diagram of an exemplary process for determining the condition of a tire using image analysis. Initially, as step 610, a tire is identified. The tire can be identified, for example, by using a RFID device. Once the tire is identified, a processor, for example, can access a baseline database to determine the tire characteristics of a tire in an acceptable condition at step 625. The acceptable condition can be determined through an initialization calibration run, at step 620, performed on the tire prior to use in the measurement system, for example. The information on tire characteristics in an acceptable condition may vary pending on climatic conditions and location. An image of the tire can then be obtained at step 630. The longitudinal distance can be extracted from the image by the processor at step 635.

The longitudinal distance of a tire can be determined through computer image analysis of a tire photo. For example, after a distance calibration for the measurement device, the tire image can be separated from the background by simply clearing the outside of a circular region of interest. The resulting image of the tire can then be thresholded to make a binary image. A software application can then parse every pixel in the image. The image can be parsed from the bottom of the image to the top of the image, for example. The software application can determine the midpoint of the tire, for example, when two rows of black pixels with less than a 5-pixel difference in length are located. The parsing can then continue along a vertical line until a white pixel is encountered. The white pixel will likely indicate where the tire rim begins in the image, for example. The length of this vertical line can then be recorded. The line represents the longitudinal distance between the rim and the riding surface.

After the longitudinal distance is determined at step 635, the longitudinal distance can then be compared against a predetermined longitudinal distance in the database to determine the condition of the tire at step 640. If the condition of the tire is unsatisfactory at step 645, the system can send a signal to a tire management system on the vehicle, for example, to inform the system of the condition of the tire and suggest a correction at step 650. Further, if the condition of the tire is unsatisfactory at step 645, the system can output the condition of the tire to a display device to warn the user of the possible hazardous condition at step 660 and end at step 699. If the tire condition is satisfactory at step 645, the system can output the satisfactory condition of the tire to the user at step 670 and end at step 699.

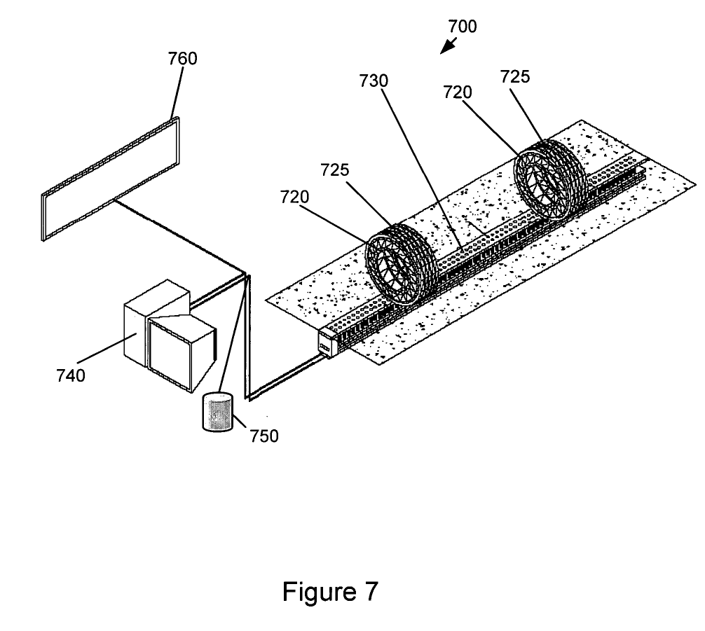

FIG. 7 is a diagram of an exemplary system implementing an infrared measurement system 700 in accordance with the present invention. The infrared measurement system 700 can comprise a tire measurement device 730 that can measure the cross-sectional temperature of the tire tread 725 of the tire 720 for analysis by the processor 740. The measurement device 730 can be an infrared sensor, for example, or an array of infrared sensors positioned along a treadle, for example. The processor 740 can compare the cross-sectional temperatures of the tire treads 725 taken by the measurement device 730 to determine whether the temperature across the tire tread is variable. The processor 740 can also compare the cross-sectional temperatures of the tire treads 725 against a database 750 with information concerning how temperatures may vary across a tire tread 725 for tires 720 operating in a satisfactory condition. A display device 760 can be used to output messages to a user (e.g., an automobile driver) concerning the condition of the tire 720 based on the analysis of the processor 740. The system may also include a signal device (not shown) to communicate with a vehicle tire management system concerning the condition of the tire 720.

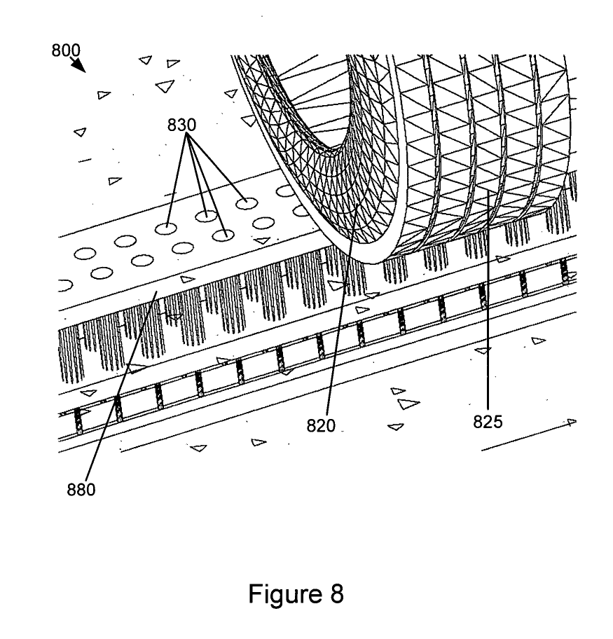

FIG. 8 is an exemplary diagram showing a close up view of an infrared analysis system 800 in accordance with the present invention. In FIG. 8, a plurality of infrared sensors 830 are implemented into a tire treadle 880 to detect the temperature of the tire tread 825 as it passes across the treadle 880.

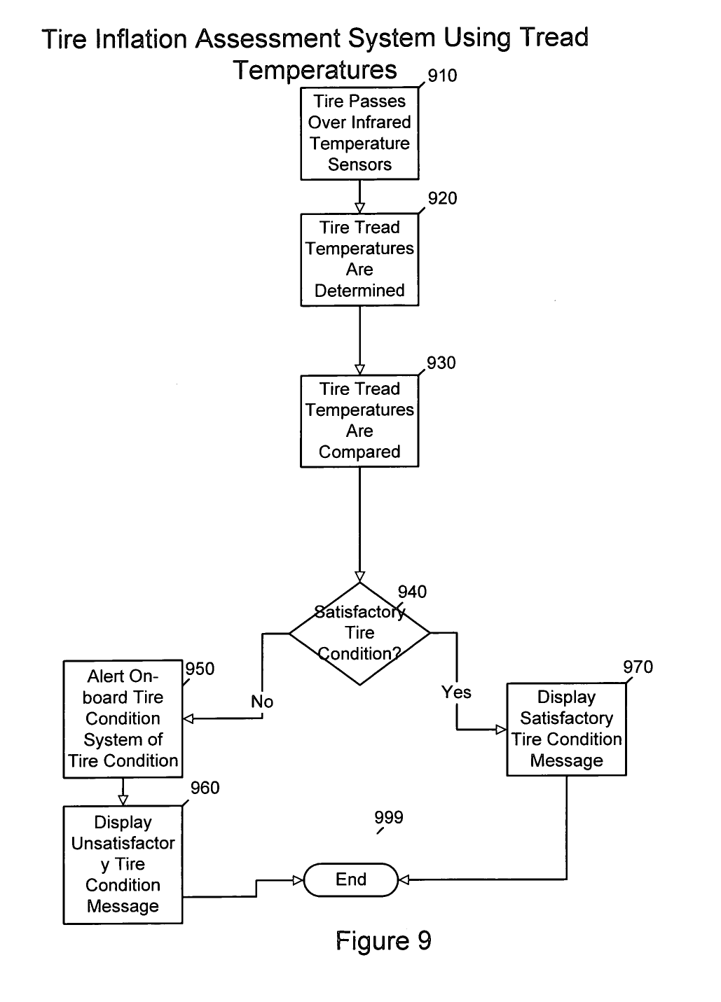

FIG. 9 is a flow diagram of an exemplary process for determining the condition of a tire using infrared analysis. Initially, as step 910, a tire begins to pass over an array of infrared sensors. The temperatures of the tire tread cross-section can be obtained at step 920. Once the temperatures of the tire tread cross-section are obtained at step 920, the temperatures of the tire tread cross-section can be compared at step 930. If the tire tread cross-section temperatures are significant different at step 930, a processor can determine whether the tire is underinflated or over inflated at step 940 and can send a signal to a tire management system on the vehicle, for example, to inform the system of the condition of the tire and suggest a correction at step 950. Further, if the condition of the tire is unsatisfactory at step 940, the system can output the condition of the tire to a display device to warn the user of the possible hazardous condition at step 960 and end at step 999. If the tire tread cross-section temperatures are not significantly different, thereby indicating a satisfactory tire condition at step 940, the system can output the satisfactory condition of the tire to the user at step 970 and end at step 999.

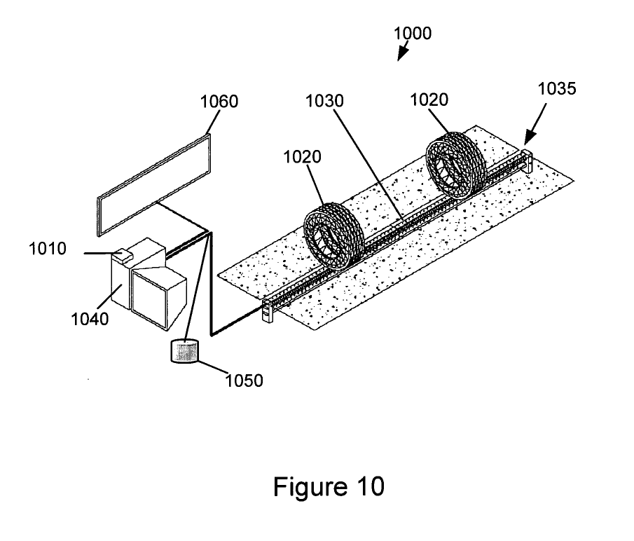

FIG. 10 is a diagram of an exemplary system implementing a strain measurement system 1000 in accordance with the present invention. The strain measurement system 1000 can comprise a tire identification device 1010 that can be used to identify a tire 1020 as it passes through the system 1000. The strain measurement system 1000 can also include a tire measurement device 1030 that can measure the strain placed on the tire treadle 1035 by the tire 1020. The measurement device 1030 can be a strain gage, for example, or an array of strain gages positioned along a treadle 1035, for example. A database 1050 can be used to store predetermined strains for the tire 1020. A processor 1040 can compare the strain values of the tire 1020 taken by the measurement device 1030 with the predetermined strain values in the database 1050, for example. A display device 1060 can be used to output messages to a user (e.g., an automobile driver) concerning the condition of the tire 1020 based on the analysis of the processor 1040. The system may also include a signal device (not shown) to communicate with a vehicle tire management system concerning the condition of the tire 1020.

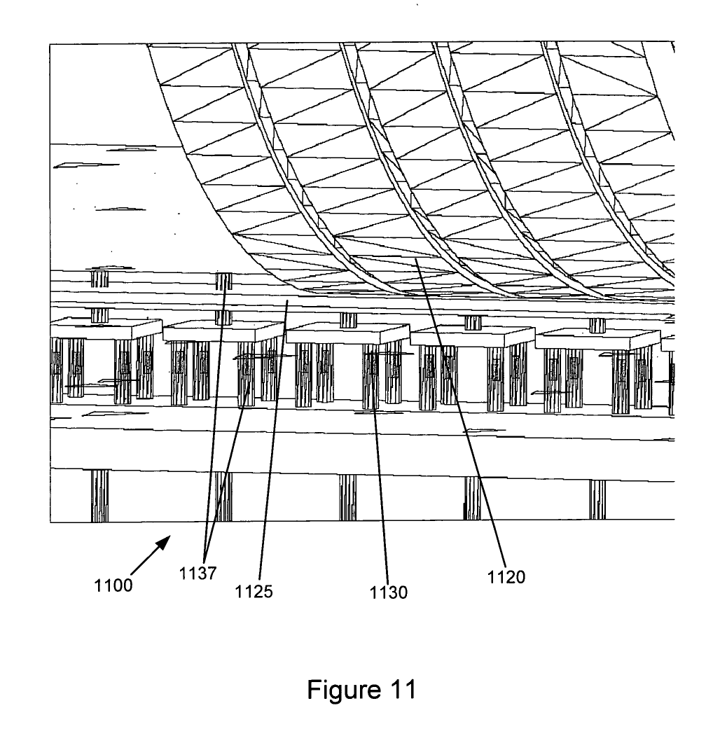

FIG. 11 is an exemplary diagram showing a close up view of the strain analysis system 1100 in accordance with the present invention. In FIG. 11, a plurality of strain sensors 1130 are implemented into a tire treadle 1125 to detect the strain placed on the tire treadle 1125 as the tire 1120 passes across the treadle 1135. The strain sensors 1130 can be mounted on pegs 1137, for example, that are depressed as the tire 1120 passes over the treadle 1135.

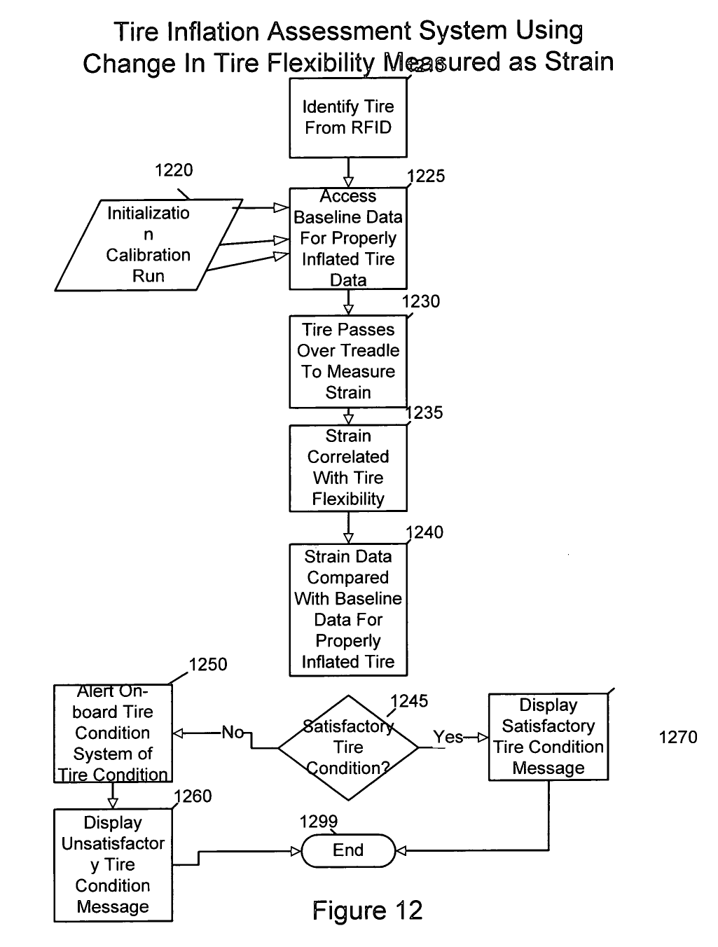

FIG. 12 is a flow diagram of an exemplary process for determining the condition of a tire using strain analysis. Initially, as step 1210, a tire is identified. The tire can be identified, for example, by using the Radio Frequency Identification Device (RFID) of the EZ Pass system. Once the tire is identified, a processor at step 1225, for example, can access a baseline database to determine the tire characteristics of the tire in an acceptable condition. The acceptable condition can be determined through an initialization calibration run, at step 1220, performed on the tire prior to use in the measurement system. The tire information may vary pending on climatic conditions and location. For example, the tire characteristics in an acceptable condition found in the database in Anchorage, Ak. can vary from those found in the database in Austin, Tex. As the tire passes over the treadle at step 1230, the strain placed on the treadle is determined. The strain determined at 1230 is then correlated with the known strain in the database at step 1235 to determine the condition of the tire. If the strain placed on the treadle is greater than the predetermined value in the database, then the tire is likely over-inflated. If, however, the strain placed on the treadle is less than the predetermined value in the database, then the tire is likely underinflated. If the strain on the treadle is approximately the same as found in the database, then the tire is likely in a satisfactory condition. The processor can then compare the current strain and the predetermined strain to determine if the tire is in a satisfactory condition at step 1240.

If the condition of the tire is unsatisfactory at step 1245, the system can send a signal to a tire management system, for example, to inform the system of the condition of the tire and the suggested correction at step 1250. Further, if the condition of the tire is unsatisfactory at step 1245, the system can output the condition of the tire to a user to warn the user of the possible hazardous condition at step 1260 and end at step 1299. If the tire condition, however, is satisfactory at step 1245, the system can output the satisfactory condition of the tire to the user at step 1270 and end at step 1299.

The system described in FIGS. 11 and 12 can also implement pressure gages in replacement of strain gages to measure the pressure of the tire as it passes across the tire treadle. The system described in FIGS. 11 and 12 can also implement other measurement devices to compare the current tire condition with a predetermined tire condition for tire analysis.

The various techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the versioning functionality of the present invention.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims.

What is claimed:

1. A system for determining a condition of a tire coupled to a moving conveyance, comprising:
at least one tire measurement device for measuring a tire characteristic of a tire coupled to a moving conveyance as the tire passes through the system; and
a processor for receiving and analyzing the tire characteristic to determine a condition of the tire.

2. The system as recited in claim 1, further comprising a display device for displaying the condition of the tire to a user.

3. The system as recited in claim 1, further comprising a tire identification device.

4. The system as recited in claim 3, wherein the tire identification device is a Radio Frequency Identification Device (RFID).

5. The system as recited in claim 1, further comprising a database, wherein said database contains a set of predetermined data on the condition of the tire.

6. The system as recited in claim 1, further comprising a communicating device for communicating with a tire management system.

7. The system as recited in claim 1, wherein the system for determining the condition of the tire is part of an electronic toll collection system.

8. A method for assessing a condition of a tire coupled to a moving conveyance, the method comprising:
sensing at least one parameter comprising a dimension, shape, load, and/or temperature of a tire while a conveyance on which the tire is coupled translates relative to a sensor;
comparing the at least one parameter to a predetermined parameter, thereby determining a condition of the tire; and
communicating the condition of the tire.

9. The method as recited in claim 8, wherein the sensing step includes assessing the at least one parameter to determine tire pressure.

10. The method as recited in claim 8, wherein the method for assessing a condition of a tire coupled to a moving conveyance is performed as the tire passes through an electronic toll collection system.

11. The method as recited in claim 8, wherein the sensing step includes determining a time period that the tire contacts a treadle and determining the conveyance velocity to determine a contact patch.

12. The method as recited in claim 8, wherein the sensing step includes determining a longitudinal distance of the tire.

13. The method as recited in claim 8, wherein the sensing step includes sensing a plurality of temperatures across a face of the tire.

14. The method as recited in claim 8, wherein the sensing step includes sensing a plurality of loads across a face of the tire.

15. The method as recited in claim 8, further comprising identifying the tire using a tire identification device.

16. The method as recited in claim 8, further comprising communicating the tire condition to a tire management system.

17. A computer readable medium having computer-executable instructions for carrying out the method of determining a condition of a tire, comprising:
determining a present condition of the tire;
comparing the present condition of the tire to a predetermined acceptable condition, wherein the predetermined condition is an acceptable tire condition stored in a database; and
displaying the condition of the tire based on said comparison between the condition of the tire and the predetermined acceptable condition.

18. The computer readable medium as recited in claim 17, further comprising instructions for identifying the tire using a tire identification device.

19. The computer readable medium as recited in claim 17, wherein said determining of the present condition of the tire occurs as the tire passes through an electronic toll collection system.

20. The computer readable medium as recited in claim 17, further comprising instructions for outputting the tire condition to a tire management system.

21. A method for determining tire pressure of a tire coupled to a moving conveyance as the conveyance passes through an electronic toll collection system, comprising:
determining a present condition of the tire, wherein the present condition of the tire is determined by calculating at least one of a contact patch, a heat distribution of a tire tread, a longitudinal distance of the tire coupled to the moving conveyance, and/or a strain placed on a treadle by the tire;
comparing the present condition of the tire to a predetermined condition, wherein the predetermined condition is an acceptable tire condition stored in a database; and
displaying the present condition of the tire based on said comparison between the present condition of the tire and the predetermined condition.
